(19) United States
(12) Patent Application Publication
(10) Pub. No.: US 2016/0008886 A1
(43) Pub. Date: Jan. 14, 2016

(54) DEVICES, SYSTEMS AND METHODS FOR PRODUCING A 3D PRINTED PRODUCT

(71) Applicant: Brett T.M. Peterson, Saint Charles, MO (US)

(72) Inventor: Brett T.M. Peterson, Saint Charles, MO (US)

(21) Appl. No.: 14/642,706

(22) Filed: Mar. 9, 2015

Related U.S. Application Data
(60) Provisional application No. 61/949,930, filed on Mar. 7, 2014.

(51) Int. Cl. B22F 3/105; B29C 67/00

(52) U.S. Cl. CPC B22F 3/1055; B29C 67/0077; B33Y 10/00

(57) ABSTRACT

The disclosure extends to methods, systems, and computer program products for producing a 3D printed product. The disclosure relates generally to 3D printing and more particularly, but not necessarily entirely, to 3D printing using metals, plastics, resins, and other materials.

### CROSS-REFERENCE TO RELATED APPLICATIONS

This application claims the benefit of U.S. Provisional Application No. 61/949,930, filed Mar. 7, 2014, which is hereby incorporated by reference herein in its entirety, including but not limited to those portions that specifically appear hereinafter, the incorporation by reference being made with the following exception: In the event that any portion of the above-referenced provisional application is inconsistent with this application, this application supersedes said above-referenced provisional application.

### STATEMENT REGARDING FEDERALLY SPONSORED RESEARCH OR DEVELOPMENT

Not Applicable.

### BACKGROUND

The disclosure relates generally to 3D printing and more particularly, but not necessarily entirely, to 3D printing using metals, plastics, resins, and other materials. What is needed are methods and systems that are efficient at 3D printing that reduces cost while still produces a quality product. As will be seen, the disclosure provides such methods and systems that can reduce cost while producing a quality 3D printed product in an effective and elegant manner.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. Advantages of the disclosure will become better understood with regard to the following description and accompanying drawings where:

FIG. 1 illustrates an implementation of a 3D printing device and system made in accordance with the teachings and principles of the disclosure;

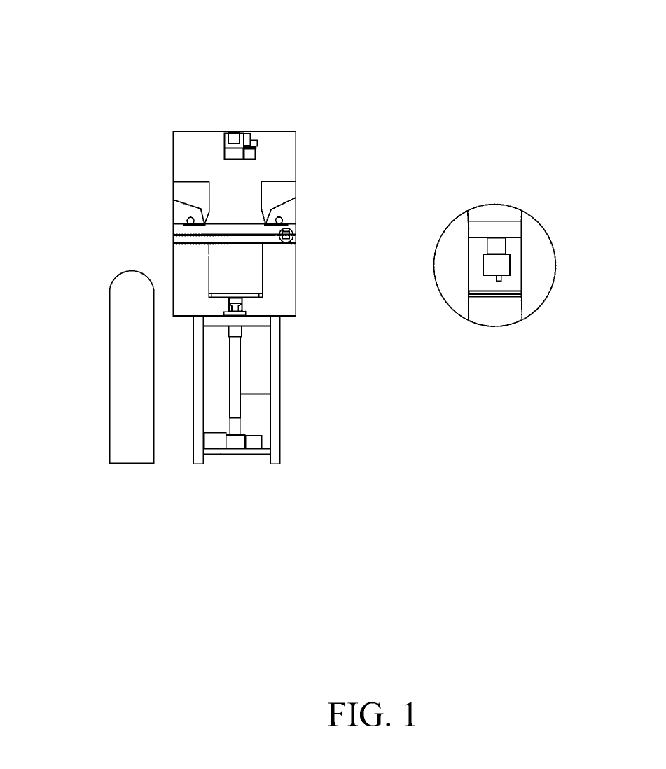

FIG. 2 illustrates an implementation of a 3D printing device and system made in accordance with the teachings and principles of the disclosure;

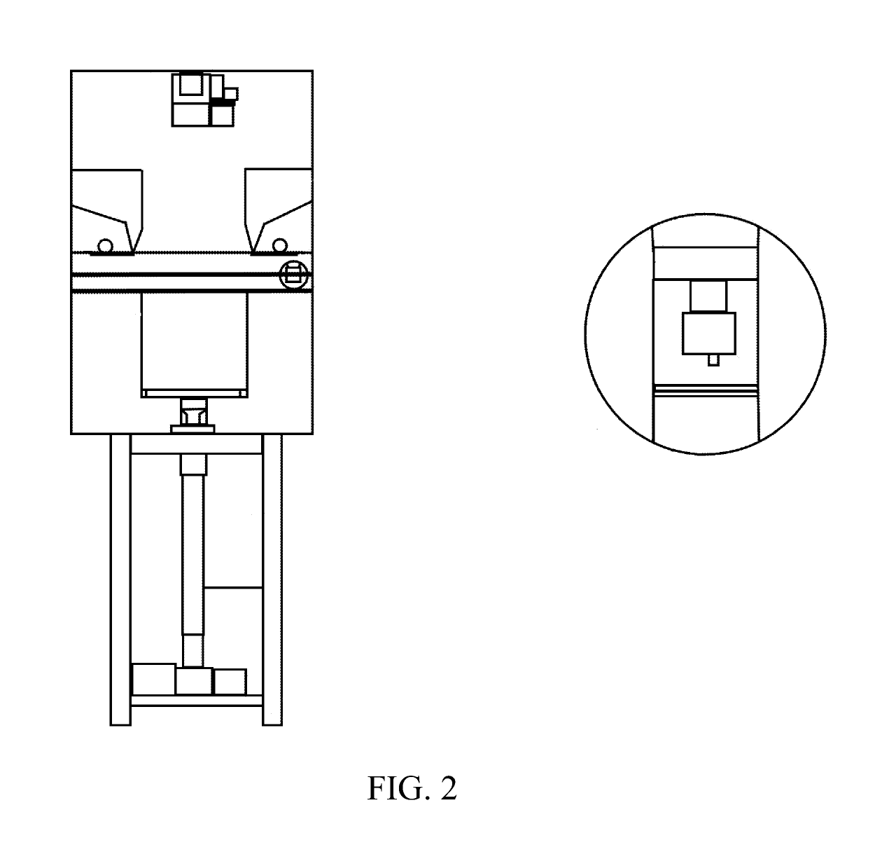

FIG. 3 illustrates an implementation of a 3D printing baseplate device made in accordance with the teachings and principles of the disclosure;

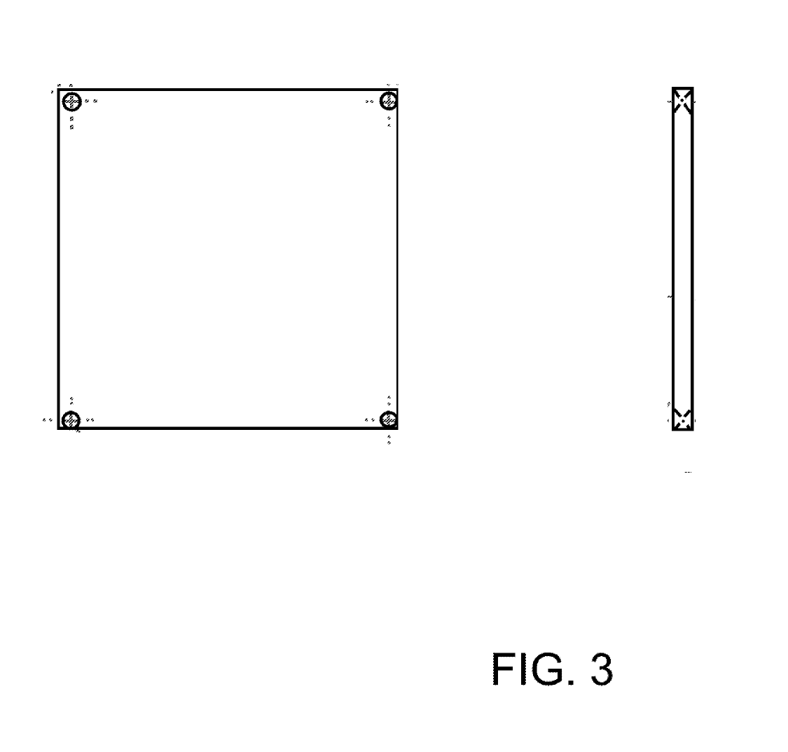

FIG. 4 illustrates an implementation of a 3D printing gate rail device made in accordance with the teachings and principles of the disclosure;

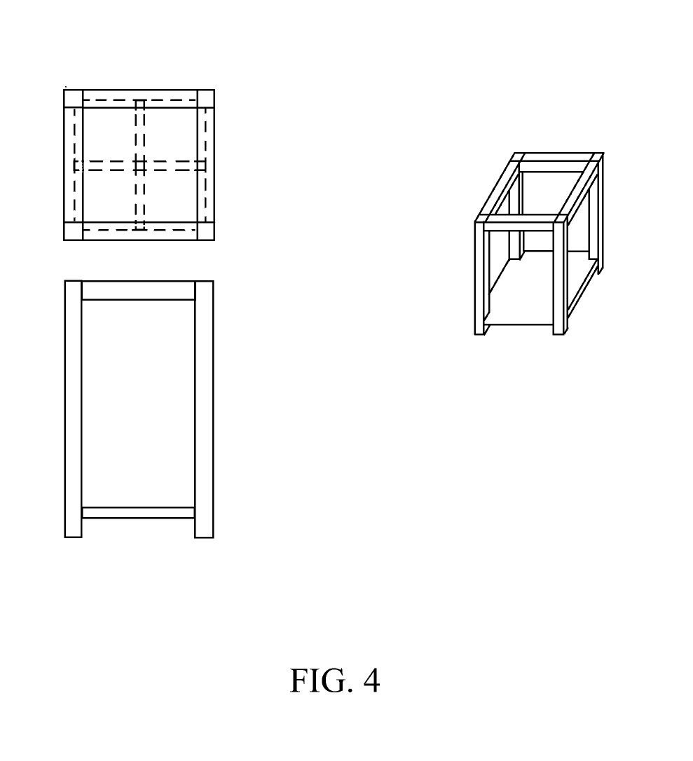

FIG. 5 illustrates an implementation of a 3D printing hopper device made in accordance with the teachings and principles of the disclosure;

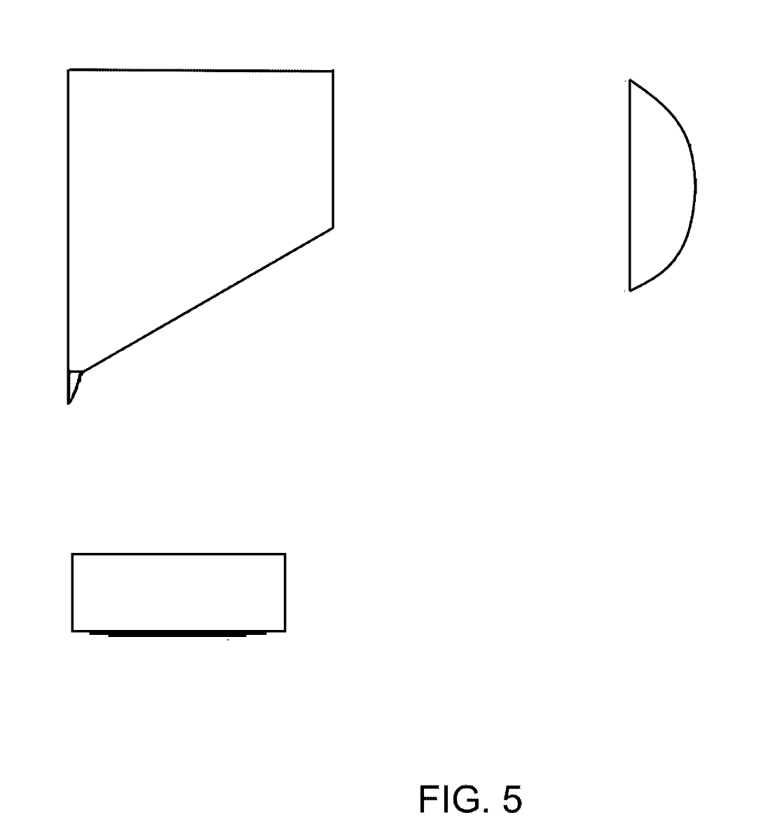

FIG. 6 illustrates an implementation of a 3D printing hopper gate device made in accordance with the teachings and principles of the disclosure;

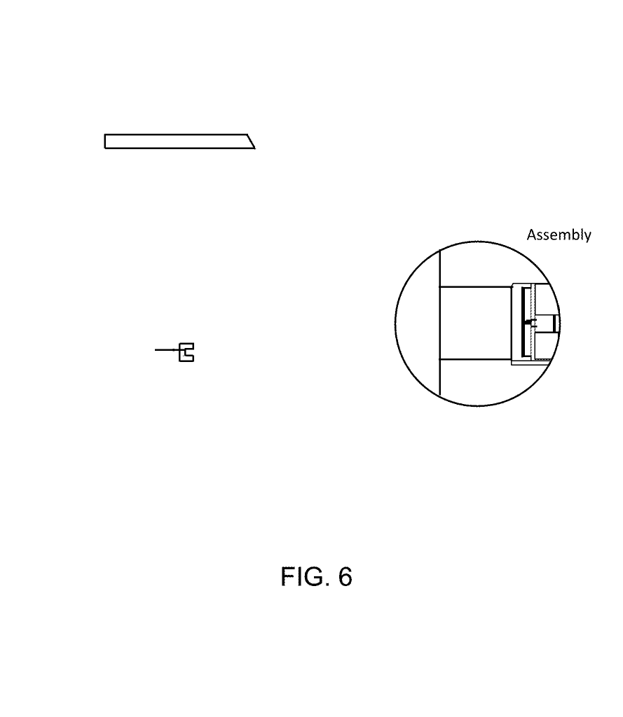

FIG. 7 illustrates an implementation of a 3D printing hopper door made in accordance with the teachings and principles of the disclosure;

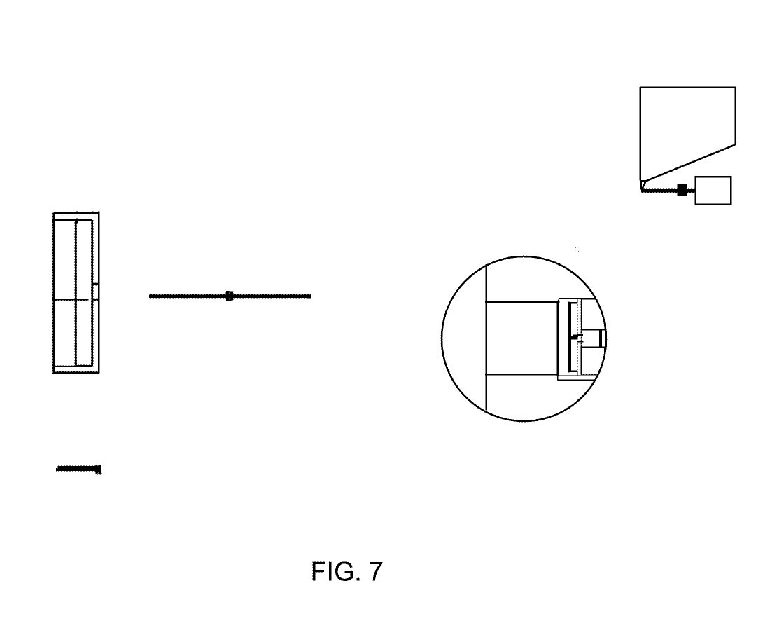

FIG. 8 illustrates an implementation of a 3D printing optics cage device made in accordance with the teachings and principles of the disclosure;

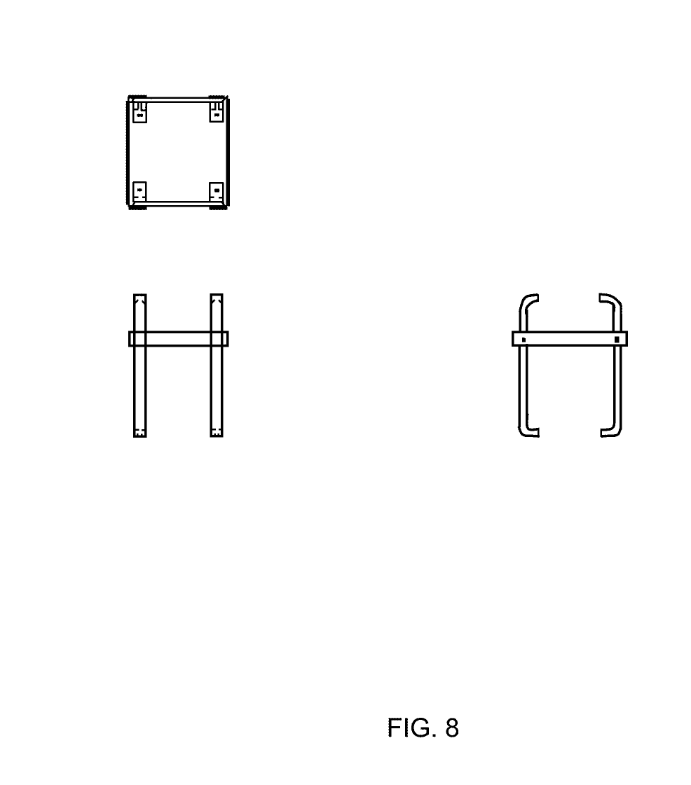

FIG. 9 illustrates an implementation of a 3D printing interface device made in accordance with the teachings and principles of the disclosure;

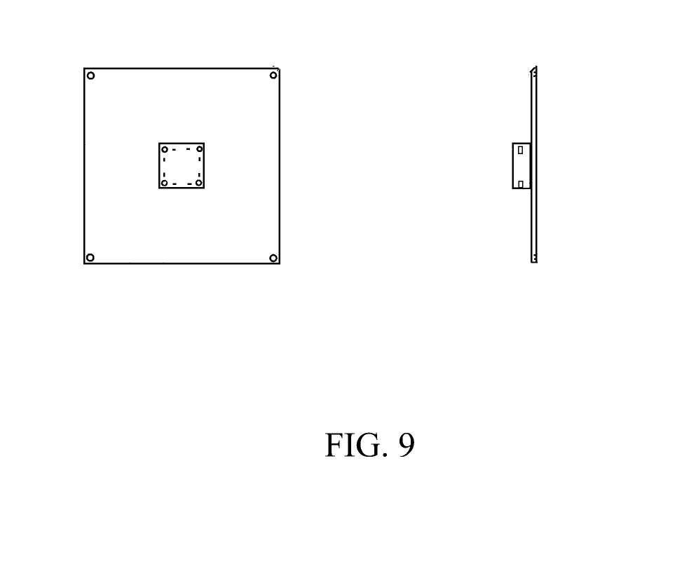

FIG. 10 illustrates an implementation of a 3D printing roller device made in accordance with the teachings and principles of the disclosure;

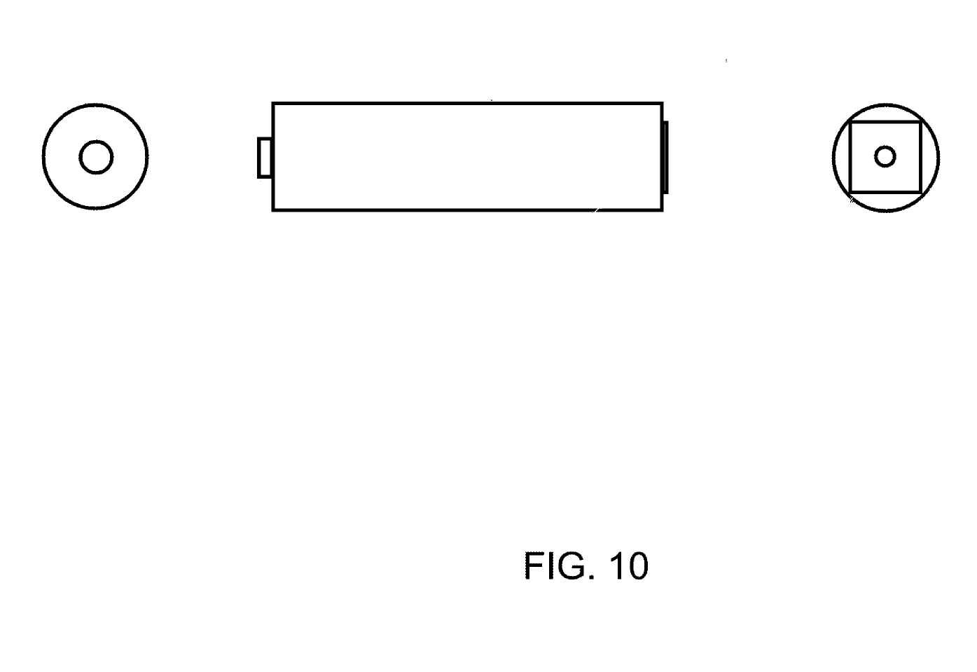

FIG. 11 illustrates an implementation of a 3D printing top plate device made in accordance with the teachings and principles of the disclosure;

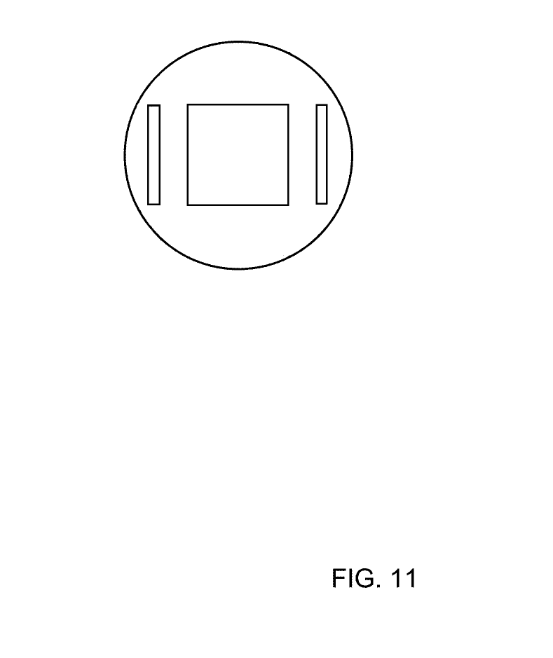

FIG. 12 illustrates an implementation of 3D printing vacuum fittings made in accordance with the teachings and principles of the disclosure;

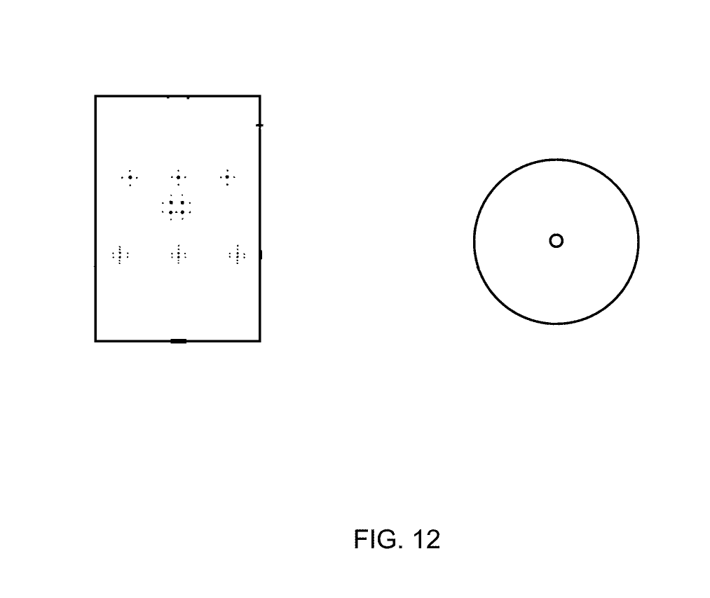

FIG. 13 illustrates an implementation of a 3D printing well cover device made in accordance with the teachings and principles of the disclosure;

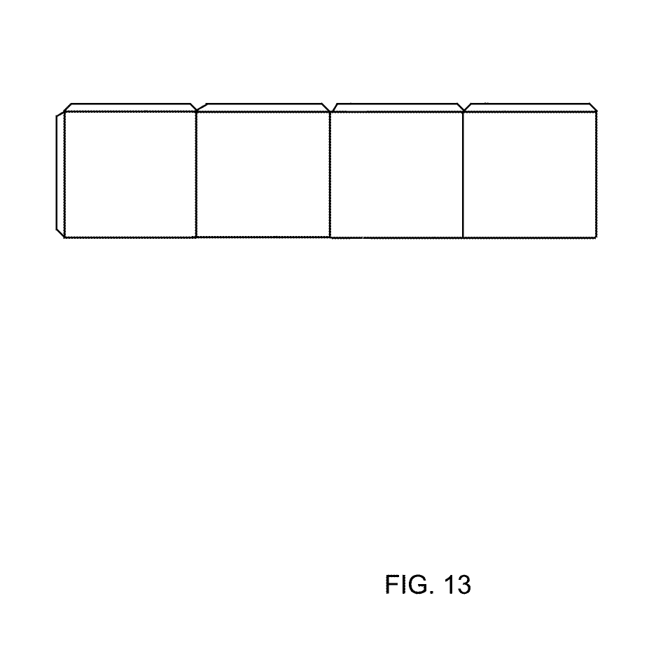

FIG. 14 illustrates a sketch of an implementation of 3D printing and beam direction in accordance with the teachings and principles of the disclosure;

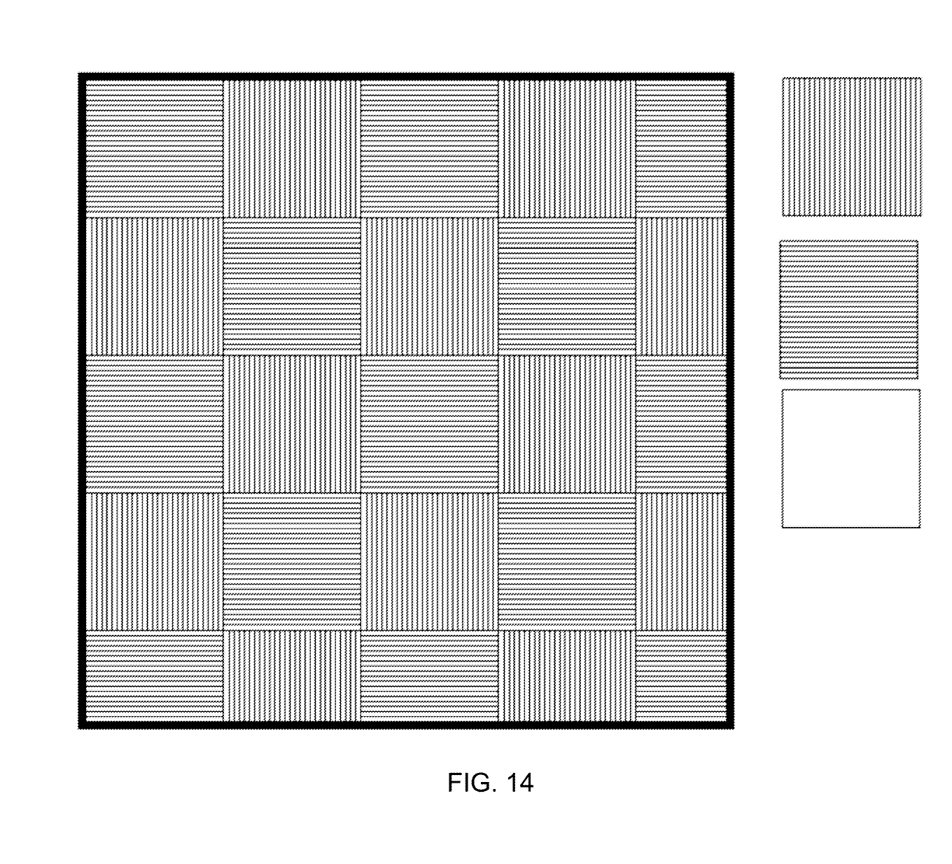

FIG. 15 illustrates a sketch of an implementation of 3D printing and multiple beam overlap in accordance with the teachings and principles of the disclosure; and

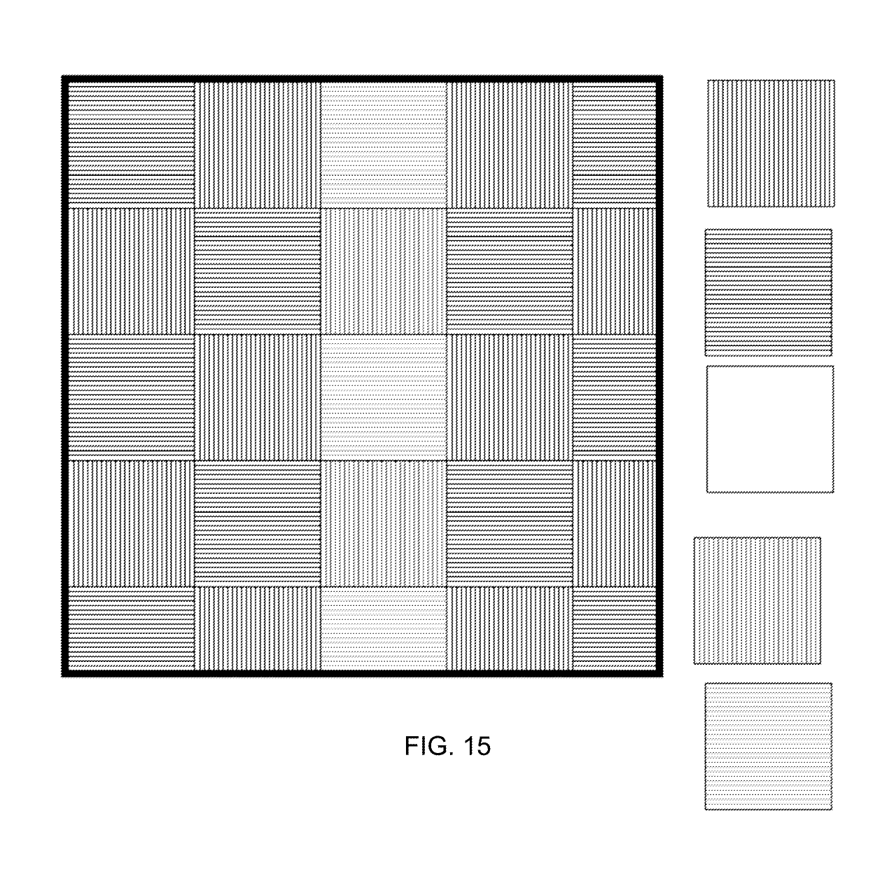

FIG. 16 illustrates a sketch of an implementation of 3D printing and beam in the same direction but providing a divided grid in accordance with the teachings and principles of the disclosure.

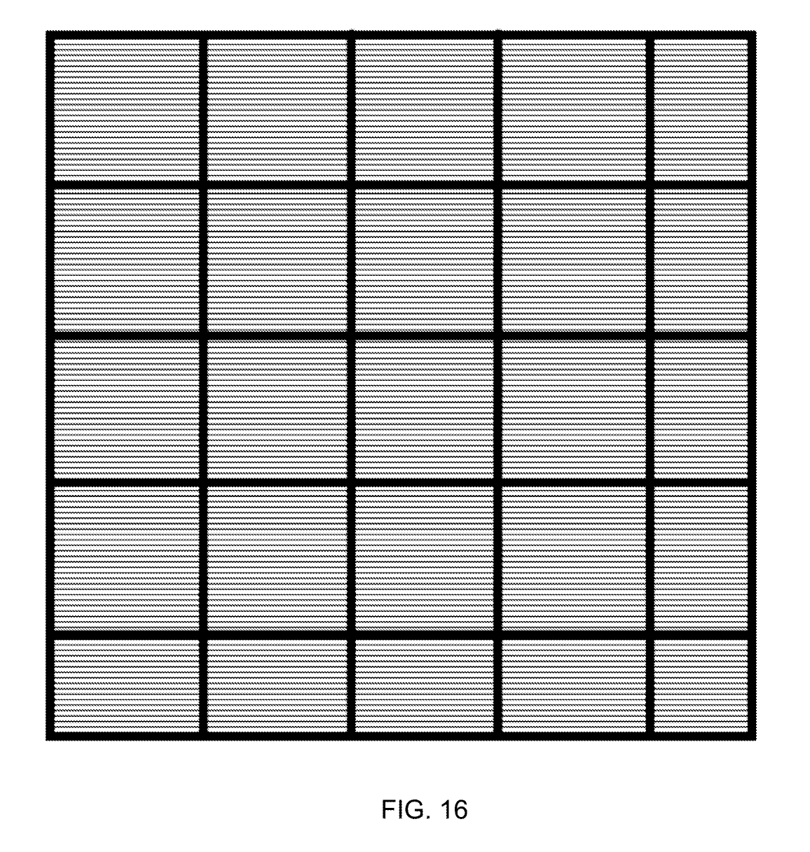

### DETAILED DESCRIPTION

The disclosure extends to methods, systems, and computer program products for producing a 3D printed product. In the following description of the disclosure, reference is made to the accompanying drawings, which form a part hereof, and in which is shown by way of illustration specific implementations in which the disclosure is may be practiced. It is understood that other implementations may be utilized and structural changes may be made without departing from the scope of the disclosure.

Using a Layer or Group of Layers as a Unit of Analysis. (Scope: All 3D Printing Systems and Processes).

Currently, software for 3d printing primarily uses the object to be printed (or manufactured additively) as the unit of analysis. In other words, the printing software and hardware primarily considers and manipulates the three dimensional file, often but not limited to .stl files, to be produced. In some software packages, the software also considers the build volume as a whole; i.e. the interaction of multiple 3D files, for example but not limited to .stl format as they are built up around each other in a single chamber. In both of these scenarios, each successive layer of powder is incidental to the build; software generally slices the file, or the build volume, into layers as a results of the file, or files, in the build volume; although layer criteria and characteristics exist, they exist as a function of the 3d file or collection of files in the build volume.

The disclosure uses the build layer itself as the unit of analysis, and then to determine, or define, the properties of the 3-dimensional file or files by controlling, first, the properties of the successive layers. This includes the constructive use of “positive” and “negative” space in each build layer, optimizing tool paths for the layer, instead of for the object as a single item or for a collection of objects to be constructed simultaneously in the build volume, and other innovations flowing from the use of the layer, not the object or build volume, as the unit of analysis and/or conceptual area of focus.

In one iteration of the system and process, we also use a collection of layers comprising a portion (but not the whole) of the complete part as a unit of analysis.

In one iteration of the system and process, we use a collection of layers as a single conceptual layer for all of the points below.

Shapes (Scope: All 3D Printing Systems and Processes).

In one iteration of the system and process, we divide each “empty” (i.e., pre-object-or-objects-to-be-printed) build layer in the additive manufacturing process into a number of tesselating or non-tesselating shapes of uniform or varied geometry for the purposes of tool path generation.

In one iteration of the system and process, we divide each “filled” (i.e. including object or objects-to-be-printed) build layer in the additive manufacturing process into a number of tesselating or non-tesselating shapes of uniform or varied geometry for the purposes of tool path generation.

In one iteration of the system and process, we divide each layer or “slice” of the object or objects to be built in the additive manufacturing process into a number of tesselating or non-tesselating shapes of uniform or varied geometry for the purposes of tool path generation.

In one iteration of the system and process, we use tessellating or non-tessellating shapes for optimized rasterized or vectored tool path generation for the production of a single object.

In one iteration of the system and process, we use tessellating or non-tessellating shapes for optimized rasterized or vectored tool path generation for the production of multiple objects in a single build chamber.

In one iteration of the system and process, we change rasterized or vectored tool path directions based on the tesselating or non-tesselating shapes (in any of the foregoing, or in any other scenarios).

In one iteration of the system and process, we use “negative” tool paths (i.e. tool paths of untreated material) based on the division of a layer of an object into tesselating or non-tesselating shapes of uniform or non-uniform geometry.

In one iteration of the system and process, we use “negative” tool paths (i.e. tool paths of untreated material) based on the division of a layer of multiple objects into tesselating or non-tesselating shapes of uniform or non-uniform geometry.

In one iteration of the system and process, we use “negative” tool paths (i.e. tool paths of untreated material) based on the division of a layer of an “empty” (i.e. without 3d dimensional objects to be printed) build layer into tesselating or non-tesselating shapes of uniform or non-uniform geometry.

In one iteration of the system and process, we offset tesselating or non-tesselating shapes of uniform or non-uniform geometry from layer to layer.

In one iteration of the system and process, we alternate tesselating or non-tesselating shapes of uniform or non-uniform geometry from layer to layer.

In one iteration of the system and process, we utilize different tesselating or non-tesselating shapes of uniform or non-uniform geometry from layer to layer.

Build without Supports.

Currently, our competitors, when 3D printing in metal using a direct metal sintering process, print support structures which support the object being printed. These require significant post-processing to remove (i.e. by grinding, polishing, cutting them away).

In one iteration of the system and process, we build without using support structures in direct metal sintering.

In one iteration of the system and process, we leave a layer or layers of untreated material between our support structures and the object being produced.

In one iteration of the system and process, we leave a layer or layers of untreated material between our support structures and the base plate (i.e. the plate upon which the build volume rests).

Non-“to-Weldable” Base Plate (Scope: All 3D Printing Systems and Processes).

Currently, direct metal sintering companies generally use a metal base plate to which support structures are welded.

In one iteration of the system and process, we use one or multiple refractory metal (i.e. one which is less chemically or thermally reactive) (including but not limited to molybdenum alloys) base plates.

In one iteration of the system and process, we use one or multiple base plates with chemical, thermal, structural, or other properties which prevent support structures from intentionally or unintentionally fastening onto the base plate.

In one iteration of the system and process, we use multiple interchangeable base plates which are, while not thermally, chemically, or otherwise non-reactive generally, are thermally, chemically, or otherwise non-reactive in comparison and or in conjunction with the additive manufacturing process generally.

In one iteration of the system and process, we use multiple interchangeable base plates which are, while not thermally, chemically, or otherwise non-reactive generally, are thermally, chemically, or otherwise non-reactive in comparison and or in conjunction with the additive manufacturing process for an additive manufacturing material in particular (i.e. but not limited to: while a steel base plate is generally reactive, it has a higher melting point than copper, and therefore may be considered a refractory metal when using the additive manufacturing process with copper).

Optimization in the X, Y, and Z Dimensions (Scope: All 3D Printing Systems and Processes).

Currently, additive manufacturing companies generate tool paths based on one or two dimensions: x and y. In essence, as additive manufacturing processes generally rely upon gravity, their tool path generation has, till now, assumed a horizontal plane.

Regardless of gravity, the disclosure uses layers in a vertical orientation (i.e. layered horizontally; hereafter referred to as “Vertical layers”) within the build volume as a conceptual model and/or unit of analysis. (Note: Without using a drawing, the best way I can illustrate this is with the following. Normally, layers are put down horizontally, as demonstrated by an equal sign: =. In our idea, we can also optimize for vertical layers layered horizontally, as in a series of capital “I”s placed next to each other: IIII)

In one iteration of the system and process, we use vertical layers layered horizontally in an additive manufacturing process.

In one iteration of the system and process, we optimize tool paths based on one or more vertical layers within the build volume.

In one iteration of the system and process, we optimize tool paths based on a combination of vertical and horizontal layers in the build volume.

In one iteration of the system and process, we optimize other aspects of the additive manufacturing process based on one or multiple vertical layers.

In one iteration of the system and process, we optimize other aspects of the additive manufacturing process based on a combination of one or more horizontal layers with one or more vertical layers.

Multiple Evacuations (Scope: All 3D Printing Systems and Processes).

Currently, competitors use dynamic venting or hard vacuum to achieve the low oxygen levels generally required for additive manufacturing in metal or other materials. This requires complex systems and high cost.

Our process is to:

a.) Partially evacuate the build chamber of atmosphere

b.) Refill the build chamber to some degree with an atmosphere suitable for additive manufacturing the material desired.

c.) Partially evacuate the chamber again to further reduce the concentration of original atmosphere.

d.) We repeat this process until the desired pressures and gas concentrations are reached.

Variable Layer Thickness (Scope: All 3D Printing Systems and Processes).

Currently, companies have a consistent layer thickness for additive manufacturing; i.e. if a part is produced using 25 micron layers, the part uses 25 micron layers throughout its volume. Generally, this is done to maintain part integrity. However, sometimes this is not desirable, as it requires additional time; for scenarios, including but not limited to decorative objects requiring very little structural integrity, much greater speed can be achieved through the use of variable layer thicknesses.

The disclosure uses a variable layer thickness, in the horizontal or vertical dimensions.

In one iteration of the system and process, the layer thickness is varied within a single part being produced; i.e. the bottom-most layer of the part is one thickness, the next layer is of a different thickness.

In one iteration of the system and process, the layer thickness is varied between parts in a single build volume a single build volume; i.e. all of the layers of one part are of one thickness, the layers of untreated material between them are of one potentially different thickness, and all of the layers of an additional part nested in the build volume above the first part are of another potentially different thickness.

In one iteration of the system and process, the layer thickness is varied both within a single part being produced (i.e. the bottom-most layer of the part is one thickness, the next layer is of a different thickness) and between parts being produced (i.e. one part has a collection of layers with variable thicknesses, the collection of layers of untreated material between them are of a potentially different set of variable thicknesses, and all of the layers of an additional part nested in the build volume above the first part are of a potentially different set of variable thicknesses).

Laser Defocusing (Scope: All 3D Printing Systems and Processes).

Currently, 3D printing companies focus a laser beam so that the beam aperture is at its optimal focal length from the build platform, or use optical systems to optimize the focal length of the beam to the distance above the build platform. In both cases, the goal is generally to determine a fixe spot size for the laser. Both solutions add considerably to the cost of additive manufacturing machine, either in expensive optics or in an expensively larger build chamber. Both solutions also “lock in” an end user to a specific spot size, which thereby determines a specific speed and accuracy.

The disclosure uses laser de-focusing to allow for a variety of spot sizes.

In one iteration of the system and process, the laser is defocused by shortening or lengthening the focal length between build volumes; i.e. a number of parts are organized in the build volume, and the entire build volume is produced layer by layer, using a single laser spot size.

In one iteration of the system and process, the laser is defocused by shortening or lengthening the focal length between parts in a single build volume; i.e. one part is produced using one spot size, and another part in the same build volume is produced using a different spot size.

In one iteration of the system and process, the laser is defocused by shortening or lengthening the focal length between layers in a single part; i.e. one layer of a part is produced using one spot size, and another layer in the same part volume is produced using a different spot size.

In one iteration of the system and process, the laser is defocused by shortening or lengthening the focal length between elements of a single layer; i.e. one portion of the layer is produced using one spot size, and another portion of the same layer is produced using a different spot size.

All Equipment Inside Vacuum Chamber.

Selective Laser Sintering currently requires an atmospheric chamber exhibiting either high vacuum, dynamic venting, or—as described previously in this application—multiple ventilations to maintain low oxygen or other gas content. This is necessary to ensure that the powder melted bonds to itself without oxidation between layers; without control of the atmosphere in the chamber, parts would have significantly lower strengths, and vastly different material properties, than parts produced in a controlled atmospheric environment. Currently, our competitors place many of the working parts of their machine outside of the atmospheric chamber to reduce the size and cost of the chamber, and to reduce the specifications required for some of their equipment. However, the interface between the chamber and the rest of the machine requires very specific and often expensive interfaces.

The disclosure places our 3D printing sub-systems inside the atmospheric chamber.

In one iteration of the system and process, all of the sub-systems necessary for selective laser sintering (atmosphere controls, build platform motors and controls, laser beam controls, the powder delivery system, and the laser generator itself, along with any other subsystems necessary for the selective laser sintering process) are placed inside the atmospheric chamber.

In one iteration of the system and process, a majority of the sub-systems necessary for selective laser sintering (atmosphere controls, build platform motors and controls, laser beam controls, the powder delivery system, and the laser generator itself, and/or any other subsystems necessary for the selective laser sintering process) are placed inside the atmospheric chamber.

Interweaving the Shapes with Multiple Lasers.

Currently, most selective laser sintering processes use a single high energy device to selectively melt powder in the additive manufacturing process. Where multiple high-energy devices are used, the coordination of the two high energy beams melting the powder prevents a significant problem. If not handled correctly, beams may cross and refract, causing inaccuracies in the placement of the laser or other type of high energy beam. Additionally, use of multiple beams requires some sort of “boundary” on the build layer to demarcate where one beam begins working, and the other beam leaves off. With current tool path generation software, this requires complex algorithms and extensive work.

The disclosure uses the SHAPES delineated above with respect to the SHAPES disclosure of this application to demarcate the boundary between laser beam fields. As the process described in the SHAPES disclosure already demarcates a single build layer into a number of tessellating or non-tessellating shapes, boundary generation is unnecessary.

In one iteration of the system and process, one laser sinters all of the material to be sintered in one direction in the boundary shapes, while another laser sinters all of the material to be sintered in a different tool path direction, as described in the alternating tool path segments of the Shapes disclosure. In this scenario, the boundary region between laser fields functions exactly the same way as the rest of the build layer, the points of connection between laser fields no different than the points of connection between any other shapes on the build layer.

In one iteration of the system and process, multiple high energy beams move completely in tandem, rasterizing different tessellating or non-tessellating shapes on the build area in the same motion. In this iteration of the idea, the beam fields overlap by the size of one shape, and one high-energy beam sinters the all of the shapes in the boundary region being sintered in one tool path direction, while the other laser sinters all of the shapes in the boundary region being sintered in an alternate tool path direction (i.e. as described in above with respect to the SHAPES disclosure).

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A method for producing a 3D printed product comprising:
providing a 3D printer comprising at least one energy beam;
sintering a powder in a pattern using the at least one energy beam; and
re-sintering at least a portion of the pattern to improve material properties of the 3D printed product.

2. The method of claim 1, wherein the at least one energy beam sinters powder in one direction of the pattern.

3. The method of claim 2, wherein a second energy beam sinters all of the material to be sintered in a different tool path direction.

4. The method of claim 3, wherein a boundary is located between energy fields of a build layer of the 3D printed product, and wherein the boundary functions the same as the rest of a build layer, such that points of connection between energy fields are no different than points of connection between any other pattern on the build layer.

5. The method of claim 1, wherein the method includes using a plurality of high energy beams that move in tandem, rasterizing different tessellating or non-tessellating shapes on a build area in the same motion.

6. The method of claim 5, wherein the energy beam fields overlap by the size of one pattern, and one high energy beam sinters all of the shapes in a boundary region being sintered in one tool path direction, while the other high energy beam sinters all of the patterns in the boundary region being sintered in an alternate tool path direction.

7. A method for producing a 3D printed product comprising:
providing a 3D printer comprising at least one energy beam;
sintering a powder in a pattern using the at least one energy beam; and
using a plurality of high energy beams that move in tandem, rasterizing different tessellating or non-tessellating shapes on a build area in the same motion.

8. The method of claim 7, wherein the method further includes re-sintering at least a portion of the pattern to improve material properties of the 3D printed product.

9. The method of claim 7, wherein at least one energy beam sinters powder in one direction of the pattern.

10. The method of claim 9, wherein a second energy beam sinters all of the material to be sintered in a different tool path direction.

11. The method of claim 10, wherein a boundary is located between energy fields of a build layer of the 3D printed product, and wherein the boundary functions the same as the rest of a build layer, such that points of connection between energy fields are no different than points of connection between any other pattern on the build layer.
